(19) United States
(12) Patent Application Publication
(10) Pub. No.: US 2023/0026929 A1
(43) Pub. Date: Jan. 26, 2023

(54) INFORMATION PROCESSING APPARATUS, INFORMATION PROCESSING METHOD, AND PROGRAM

(71) Applicant: SONY GROUP CORPORATION, Tokyo (JP)

(72) Inventor: Masakazu EBIHARA, Tokyo (JP)

(73) Assignee: SONY GROUP CORPORATION, Tokyo (JP)

(21) Appl. No.: 17/786,306

(22) PCT Filed: Dec. 16, 2020
(86) PCT No.: PCT/JP2020/046929

§ 371 Date: Jun. 16, 2022

(30) Foreign Application Priority Data
Dec. 27, 2019 (JP) 2019-239553

(51) Int. Cl. G06Q 50/20; G06V 20/52

(52) U.S. Cl. CPC G06Q 50/205; G06V 20/52

(57) ABSTRACT

In order to achieve the above object, an information processing apparatus according to an embodiment of the present technology includes an evaluation unit. The evaluation unit sets an evaluation value relating to an educational situation on the basis of a correlation between educator action information, which is a classification result obtained by classifying an action of an educator into one of a plurality of educator action patterns, and learner action information, which is a classification result obtained by classifying an action of a learner into one of a plurality of learner action patterns.

### TECHNICAL FIELD

The present technology relates to an information processing apparatus, an information processing method, and a program that are applicable to evaluation of lectures or the like.

### BACKGROUND ART

In the lecture video analysis apparatus described in Patent Literature 1, a video in which a participant who views a lecture video is imaged is acquired. Positive or negative reactions of the participant about the lecture are recognized from the acquired video, and the degree of understanding of the participant about the lecture is estimated. This is intended to serve for improving the degree of understanding of the participant and improving the content of the lecture video.

### CITATION LIST

### Patent Literature

Patent Literature 1: Japanese Patent Application Laid-open No. 2018-155825

### DISCLOSURE OF INVENTION

### Technical Problem

There is a need for a new technique for evaluating a lecture or the like as described in Patent Literature 1.

In view of the above circumstances, it is an object of the present technology to provide an information processing apparatus, an information processing method, and a program that are capable of performing an evaluation on a lecture or the like, which has not been performed so far.

### Solution to Problem

In order to achieve the object described above, an information processing apparatus according to an embodiment of the present technology includes an evaluation unit.

The evaluation unit sets an evaluation value relating to an educational situation on the basis of a correlation between educator action information, which is a classification result obtained by classifying an action of an educator into one of a plurality of educator action patterns, and learner action information, which is a classification result obtained by classifying an action of a learner into one of a plurality of learner action patterns.

In this information processing apparatus, an evaluation value relating to an educational situation is set on the basis of a correlation between educator action information, which is a classification result obtained by classifying an action of an educator into one of a plurality of educator action patterns, and learner action information, which is a classification result obtained by classifying an action of a learner into one of a plurality of learner action patterns. This makes it possible to carry out an evaluation that has not been performed so far.

The correlation may be a correlation between the educator action information, and first learner action information and second learner action information as the learner action information.

The correlation may be a correlation between the first learner action at a first timing, the educator action information at a second timing, which is a timing after the first timing, and the second learner action information at a third timing, which is a timing after the second timing.

When the first learner action information and the second learner action information are different from each other, the evaluation unit may set the evaluation value higher than an evaluation value in a case where the first learner action information and the second learner action information are identical to each other.

When the first learner action information and the second learner action information are different from each other, the evaluation unit may set the evaluation value high if the second learner action information is set as more positive action information than the first learner action information.

When the first learner action information and the second learner action information are different from each other, the evaluation unit may set the evaluation value high if the second learner action information is set as more negative action information than the first learner action information.

When the first learner action information and the second learner action information are identical to each other, the evaluation unit may set the evaluation value lower than an evaluation value in a case where the first learner action information and the second learner action information are different from each other.

The information processing apparatus may further include an analysis unit that classifies the action of the educator into one of the plurality of educator action patterns to generate the educator action information, classifies the action of the learner into one of the plurality of learner action patterns to generate the learner action information, and outputs the generated educator action information and learner action information to the evaluation unit.

The information processing apparatus may further include a sensor unit that outputs a sensing result to the analysis unit. In this case, the analysis unit may analyze the action of the educator and the action of the learner on the basis of the sensing result.

The information processing apparatus may further include an evaluation correspondence processing unit that processes the sensing result on the basis of the evaluation value.

The evaluation correspondence processing unit may edit the sensing result on the basis of the evaluation value.

The information processing apparatus may further include an evaluation correspondence processing unit that processes the sensing result on the basis of the evaluation value.

The evaluation correspondence processing unit may edit the sensing result on the basis of the evaluation value.

An information processing method according to an embodiment of the present technology is an information processing method executed by a computer system and including setting an evaluation value relating to an educational situation on the basis of a correlation between educator action information, which is a classification result obtained by classifying an action of an educator into one of a plurality of educator action patterns, and learner action information, which is a classification result obtained by classifying an action of a learner into one of a plurality of learner action patterns.

A program according to an embodiment of the present technology causes a computer system to execute the step of setting an evaluation value relating to an educational situation on the basis of a correlation between educator action information, which is a classification result obtained by classifying an action of an educator into one of a plurality of educator action patterns, and learner action information, which is a classification result obtained by classifying an action of a learner into one of a plurality of learner action patterns.

### BRIEF DESCRIPTION OF DRAWINGS

FIG. 1 is a schematic diagram for describing an example of an evaluation system.

FIG. 2 is a schematic diagram showing an application example of the evaluation system.

FIG. 3 is a block diagram showing a functional configuration example of the evaluation system and an information processing apparatus.

FIG. 4 is a flowchart showing an example of generating evaluation information.

FIG. 5 shows tables showing speeches and actions of a TA and students in class.

FIG. 6 shows examples of an evaluation table for calculating an evaluation value.

FIG. 7 is a schematic diagram showing the correlations in conversations between students.

FIG. 8 is a schematic diagram showing the segments of partial content of a class and the evaluation value of each piece of partial content.

FIG. 9 is a schematic diagram showing partial content to be recorded.

FIG. 10 is a block diagram showing a hardware configuration example of the information processing apparatus.

### MODE(S) FOR CARRYING OUT THE INVENTION

Hereinafter, an embodiment of the present technology will be described with reference to drawings.

[Evaluation System]

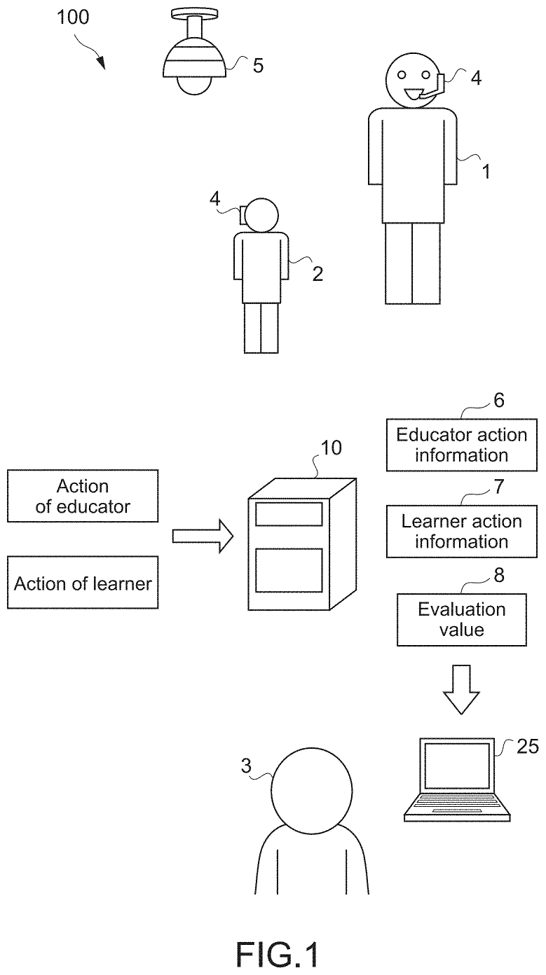

FIG. 1 is a schematic diagram for describing an example of an evaluation system according to the present technology.

In an evaluation system 100 according to the present technology, it is possible to perform various evaluations regarding an educational situation of an educator (instructor or teacher) 1 and a learner 2.

For example, as shown in FIG. 1, a user 3 can efficiently and accurately perform various evaluations regarding an educational situation by using the evaluation system 100.

The educator 1 includes any person who teaches educational content to the learner 2. Of course, the content to be taught is not limited, and it includes any content.

For example, the “educator” includes teachers who teach in schools, teaching assistants (TA) who assist in the progress of classes, coaches who teach sports and the like, seniors who teach jobs, and the like. In addition, the “educator” includes any person in a teaching position, such as a tutor, a mentor, a professor, a master, or instructor.

The learner 2 includes any person who learns the content of the education by the educator 1. As described above, since the content of the education taught by the educator 1 is not limited, the content learned by the learner 2 is not limited, and any content is included.

For example, the “learner 2” includes students who learn at school, athletes who practice sports and the like, juniors who learn jobs, and the like. In addition, the “learner 2” includes any person in a learning position, such as a tutee, a mentee, or a disciple.

Note that a plurality of persons in a position to be referred to under the same name may become an educators 1 and a learner 2. For example, when one student teaches something to another student, the teaching student becomes the educator 1 and the student being taught becomes the learner 2.

In addition, when a teacher is displayed by a video or the like, and the student studies while viewing the video or the like, it is also possible to consider the teacher appearing in the video as the educator 1, and consider the student learning while viewing the video as the learner 2.

In this disclosure, the educational situation includes any situation in which an educator 1 teaches the educational content to a learner 2 and the learner 2 learns the educational content. For example, teachers give classes to students in school classrooms, coaches give instruction to athletes in playgrounds, and seniors give explanations to juniors at companies. In addition, any other situations in which education and learning are performed, such as lectures, exercises, experiments, practical training, and practical skill training, are included.

Further, the educational situation can be performed without limiting the number of educators 1 and the number of learners 2. In other words, various situations to be described below are conceivable.

Educational situation performed by one educator 1 and one learner 2

Educational situation performed by one educator 1 and a plurality of learners 2

Educational situation performed by a plurality of educators 1 and one learner 2

Educational situation performed by a plurality of educators 1 and a plurality of learners 2

The present technology is applicable to various forms of the educational situations as described above.

Note that if there is a plurality of educators 1, this can be expressed as an educational situation performed by a first group with the attribute of a teacher can be used. Further, the educator 1 can also be said to be a person who belongs to the first group with the attribute of a teacher.

Similarly, if there is a plurality of learners 2, this can be expressed as an educational situation performed by a second group with the attribute of a learner. Further, the learner 2 can also be said to be a person who belongs to the second group with the attribute of a learner.

As shown in FIG. 1, the evaluation system 100 according to this embodiment includes a sensor unit, an information processing apparatus 10, and a user terminal 25.

The sensor unit, the information processing apparatus 10, and the user terminal 25 are communicably connected via wired or wireless communication. The form of connections between the devices is not limited, and wireless LAN communication such as WiFi or short-range wireless communication such as Bluetooth (registered trademark) can be used, for example.

The sensor unit can detect various types of data relating to the educator 1 and the learner 2. For example, the sensor unit is installed in an environment where teaching and learning are performed, and is achieved by a microphone 4 capable of detecting sound generated in the periphery, a camera 5 capable of capturing an image of the periphery, and the like.

In this embodiment, the sensing result sensed by the sensor unit includes both data that can be used as content browsable/viewable by the user 3 and data for detecting the actions of the educator 1 and the learner 2. Of course, the sensing result also includes data that can be used as content and can also be used to detect the actions of the educator 1 and the learner 2, and data that cannot be used as content but can be used to detect the actions of the educator 1 and the learner 2.

Examples of the content include video, sound, and the like of the educational situation of the educator 1 and the learner 2.

The data for detecting the actions of the educator 1 and the learner 2 includes, for example, a sound pressure emitted from the learner 2, positional information indicating the position of the educator 1, and the like.

For example, the microphone 4 can detect sounds emitted from the educator 1 and the learner 2. Further, the camera 5 can capture images of the faces and the like of the educator 1 and the learner 2 and the actions of the educator 1 and the learner 2. Further, the camera 5 can capture a video of an environment such as a classroom in which the camera 5 is disposed.

The sound, video, and the like detected by the microphone 4 and the camera 5 can be used as content, and can also be used for detecting the actions of the educator 1 and the learner 2. Needless to say, the present technology is not necessarily limited to the case where the sound, video, and the like obtained by the microphone 4 and the camera 5 are used as content and are also used to detect the actions of the educator 1 and the learner 2. The sound, video, and the like obtained by the microphone 4 and the camera 5 may be used only as content or may be used only to detect the actions of the educator 1 and the learner 2.

Specific devices used as a sensor unit are not limited. For example, as the camera 5, imaging devices such as a digital camera, a ToF (Time of Flight) camera, a stereo camera, a monocular camera, an IR camera, a polarization camera, and other cameras may be used.

Further, for example, a biological sensor, a laser ranging sensor, a contact sensor, an ultrasonic sensor, LiDAR (Light Detection and Ranging, Laser Imaging Detection and Ranging), a sonar, and a beacon may be used as the sensor unit.

The sensing result detected by those devices may be appropriately used as content, data for detecting the actions of the educator 1 and the learner 2, or both of them.

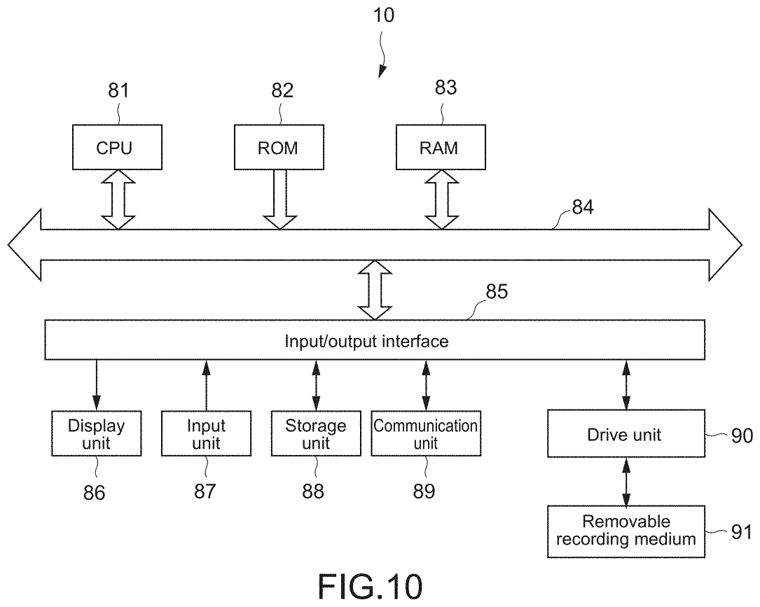

The information processing apparatus 10 includes hardware necessary for the configuration of the computer, e.g., a processor such as a CPU or a GPU, a memory such as a ROM or a RAM, a storage device such as an HDD, and the like (see FIG. 10). For example, when the CPU loads a program according to the present technology, which is recorded in advance in the ROM or the like, into the RAM and executes it, the information processing method according to the present technology is executed.

For example, the information processing apparatus 10 can be implemented by any computer such as a personal computer (PC). Of course, hardware such as a FPGA or ASIC may be used.

In this embodiment, the CPU executes a predetermined program to configure an evaluation information generation unit as a functional block. Of course, dedicated hardware such as an integrated circuit (IC) may be used to implement the functional blocks.

The program is installed in, for example, the information processing apparatus 10 via various recording media. Alternatively, the program may be installed via the Internet or the like.

The type or the like of the recording medium on which the program is recorded is not limited, and any computer-readable recording medium may be used. For example, any non-transitory computer-readable storage medium may be used.

As shown in FIG. 1, the information processing apparatus 10 sets an evaluation value relating to an educational situation on the basis of a correlation between educator action information 6, which is a classification result obtained by classifying the action of the educator 1 into one of a plurality of educator action patterns, and learner action information 7, which is a classification result obtained by classifying the action of the learner 2 into one of a plurality of learner action patterns.

The action of the educator 1 is the action of the educator 1 in an educational situation and includes, for example, the speeches and actions of the educator 1 relating to a class. The speeches and actions of the educator 1 relating to a class include, for example, explanations to all the learners 2, and various actions to the learners 2, such as advice (speeches) to a group including one educator 1 or a plurality of learners 2. Note that the action of the educator 1 is not limited and may include an action not directed to the learner 2. For example, board writing, pointing to a material, conversations between the educators 1, movement, the volume of voice of the educator 1, or the like may be included.

The action of the learner is the action of the learner 2 in an educational situation and includes, for example, the speeches and actions of the learner 2 relating to a class. The speeches and actions of the learner 2 relating to a class include, for example, questions to the educator 1, discussions between the learners 2, the content of the discussion, the volume of voice, the act of copying or taking notes of the board writing, and the like.

Note that the board writing and speeches include the actions of performing board writing and speeches and the content of board writing and speeches.

Further, the actions of the educators and learners are not limited. For example, those actions may include the learner 2 listening quietly to the explanation of the educator 1, and the educator 1 stopping to look at the learner 2. Actions unrelated to the educational situation, such as doing nothing and sleeping, may also be included.

The educator action pattern and the learner action pattern are types of actions of the educator 1 and the learner 2 registered in advance in an analysis unit 13. For example, an explanation to all, advice to the learner 2, and movement are included.

The educator action information 6 and the learner action information 7 are classification results classified into one of the educator action pattern and the learner action pattern. For example, when the action of the educator 1 such as speaking in front of a monitor is analyzed, the action is classified into “explanation to all” in the educator action pattern. Note that the method of generating the educator action information 6 and the learner action information 7 is not limited. For example, machine learning may be performed by the information processing apparatus 10 to distinguish the educator 1 from the learner 2, so that the educator action information 6 and the learner action information 7 may be generated.

For example, any machine-learning algorithm using a deep neural network (DNN) or the like may be used. For example, by using artificial intelligence (AI) or the like that performs deep learning, it is possible to improve the generation accuracy of the educator action information 6 and the learner action information 7.

Hereinafter, the educator action information 6 and the learner action information 7 may be referred to as action information.

An evaluation value 8 generated by the information processing apparatus 10 is output to an evaluation correspondence processing unit 18.

Regarding the evaluation value 8 relating to the educational situation, an evaluation table registered in advance in an evaluation unit 16 is referred to on the basis of the correlation between the educator action information and the learner action information, which are the classification results of the analysis unit 13, and if there is a corresponding correlation, the point thereof is set as an evaluation value. Note that the evaluation table may be stored in a recording unit 11.

The user terminal 25 includes various devices usable by the user 3. For example, a PC, a smart phone, or the like is used as the user terminal 25. The user 3 can access the evaluation system 100 via the user terminal 25. For example, the user 3 can perform various settings such as evaluation of an educational situation or can view content by using the user terminal 25.

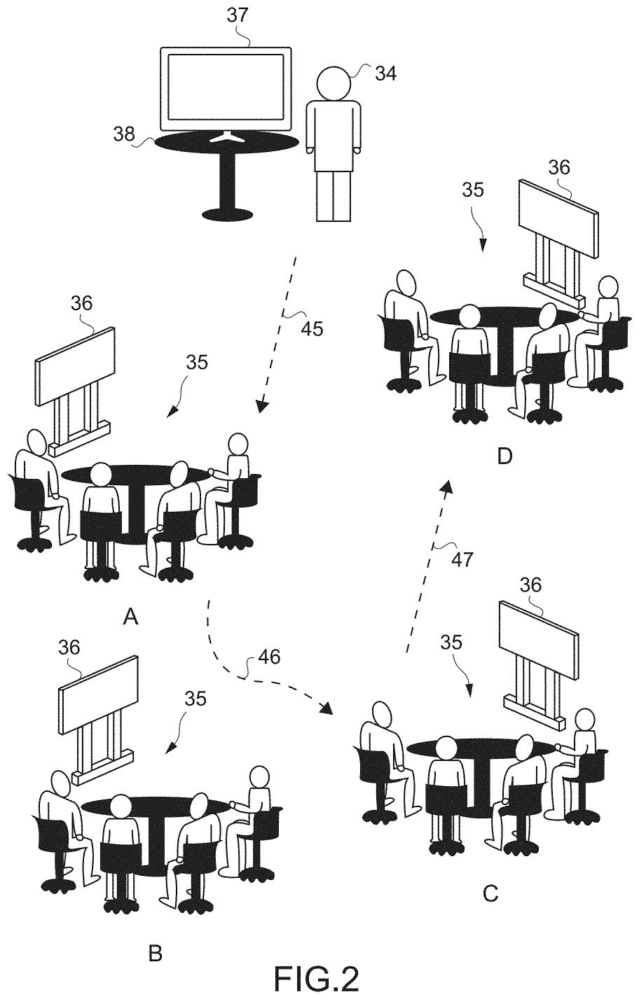

FIG. 2 is a schematic diagram showing an application example of the evaluation system 100. In the example shown in FIG. 2, a TA 34 is shown as the educator 1. In addition, four students 35 are shown as the learners 2 in each of pods A, B, C, and D.

In this embodiment, a form of class called active learning, in which discussions are held among the students 35 on an agenda and the students 35 can learn actively, is implemented in the classroom.

The TA 34 supports the students 35 by giving advice and facilitating discussions to the students 35 in each pod. The students 35 in each pod discuss the agenda and seek answers to the agenda. Note that the TA 34 and the students 35 include a group of a plurality of TAs 34 and a group (pod) of a plurality of students 35. In other words, if “the speech of the TA 34” is described, this includes both the speech of one TA 34 and the speech of the group of TAs 34.

Further, in FIG. 2, the camera and the microphone are not shown. In this embodiment, a camera and a microphone for acquiring the actions and speeches of the TA 34 are disposed. For example, a camera is provided on the ceiling or the like of a classroom where active learning is performed, and the action of the TA 34 is acquired. Further, the TA 34 may carry the microphone to acquire the voice of the TA 34.

Further, in this embodiment, a camera and a microphone for acquiring the actions and speeches of the students 35 are disposed. For example, a camera and a microphone are disposed in each pod, and thus the actions and the speeches of the students 35 are acquired. Further, a whiteboard 36 for the students 35 to perform board writing is disposed for each pod. Further, the camera disposed in each pod can acquire the content of board writing on the whiteboard 36.

Further, in this embodiment, a monitor 37 for displaying materials and the like used by the TA 34 in classes and a table 38 for the TA 34 are arranged.

Note that the equipment used for the active learning is not limited. For example, a monitor, a PC, or the like may be disposed in each pod.

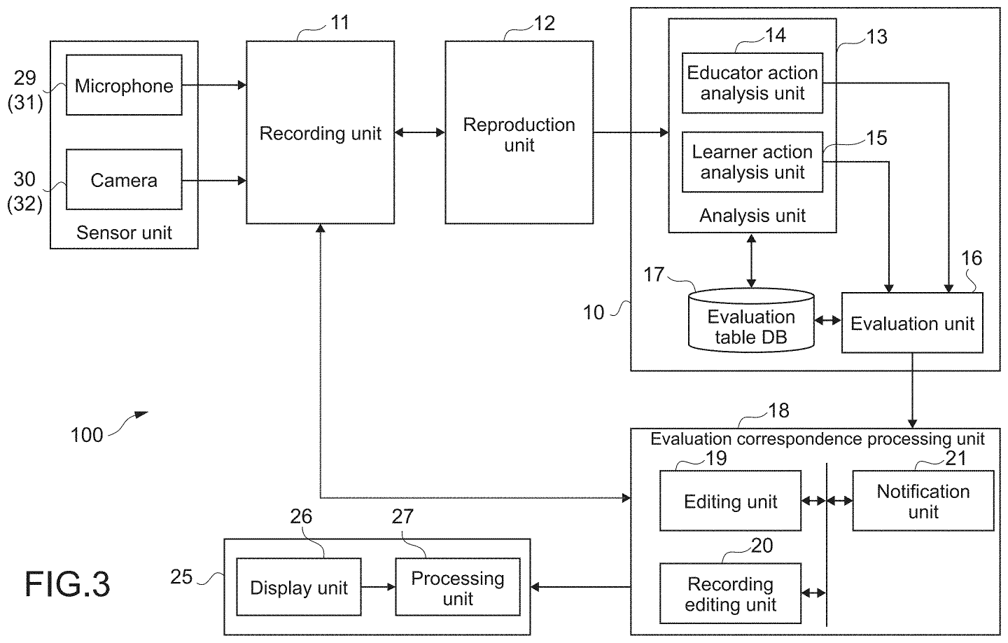

FIG. 3 is a block diagram showing a functional configuration example of the evaluation system 100 and the information processing apparatus 10.

In this embodiment, the evaluation system 100 includes the sensor unit, the recording unit 11, a reproduction unit 12, the information processing apparatus 10, the evaluation correspondence processing unit 18, and the user terminal 25.

The recording unit 11 acquires and records a sensing result output from the sensor unit including a microphone 29 (31) and a camera 30 (32). In this embodiment, the sound data and the image data output from the microphone 29 and the camera 30 for the TA 34 and from the microphone 31 and the camera 32 for the student 35 are acquired and recorded.

Note that, in the following description, the sound and video recorded in the recording unit 11 are referred to as content. The content includes the sound and overview video acquired by the microphone 29 and the camera 30, and the sound and video of each pod acquired by the microphone 31 and the camera 32.

The recording unit 11 outputs the recorded content to the reproduction unit 12.

The reproduction unit 12 can reproduce the content. In this embodiment, the content acquired by the microphone 29 (31) and the camera 30 (32) is input by the recording unit 11, and the content can be reproduced.

The reproduction unit 12 outputs the input sensing result to the analysis unit 13.

The information processing apparatus 10 includes the analysis unit 13, the evaluation unit 16, and an evaluation table DB 17.

The analysis unit 13 includes an educator action analysis unit 14 and a learner action analysis unit 15.

The educator action analysis unit 14 analyzes the action of the educator 1 from the sensing result input from the reproduction unit 12. In this embodiment, the action of the TA 34 is analyzed on the basis of the sensing result. For example, speech analysis is performed on the basis of the sensing result acquired by the microphone 29 to analyze the presence or absence of a speech of the TA 34 to the student 35 and the content of the speech. Further, for example, video recognition is performed on the basis of the sensing result acquired by the cameras 30 to analyze the movement of the TA 34 in the classroom.

From the analysis result, the educator action analysis unit 14 classifies the action of the educator 1 on the basis of the educator action patterns registered in advance in the evaluation table DB 17.

The educator action analysis unit 14 outputs the action of the educator 1 classified as one of the educator action patterns, as educator action information, to the evaluation unit 16.

The learner action analysis unit 15 analyzes the action of the learner 2 from the sensing result input from the reproduction unit 12. In this embodiment, the action of the student 35 is analyzed on the basis of the sensing result. For example, speech analysis is performed on the basis of the sensing result acquired by the microphone 31 to analyze the presence or absence of a speech relating to the class of the student 35 and the content of the speech. Further, for example, video recognition is performed on the basis of the sensing result acquired by the camera 32 to analyze the action of the student 35, such as board writing.

From the analysis result, the learner action analysis unit 15 classifies the action of the learner 2 on the basis of the learner action patterns registered in advance in the evaluation table DB 17.

The learner action analysis unit 15 outputs the action of the learner 2 classified as one of the learner action patterns, as learner action information, to the evaluation unit 16.

The evaluation unit 16 sets an evaluation value on the basis of the correlation between the educator action information and the learner action information output from the analysis unit 13.

In this embodiment, the evaluation value is set on the basis of the correlation between first learner action information at a first timing, educator action information at a second timing, which is the timing after the first timing, and second learner action information at a third timing, which is the timing after the second timing.

In other words, in the present disclosure, the chronological order in which the action of the educator 1 intervenes with respect to the action of the learner 2, for example, is the correlation.

For example, the amount of conversation of the learner 2 at the first timing, the advice of the educator 1 at the second timing, which is the timing after the first timing, and the amount of conversation of the learner 2 at the third timing, which is the timing after the second timing, are the correlation.

It can also be said that the correlation includes the relationship when the action of the learner 2 changes due to the action of the educator 1 to the learner 2. The present technology is not limited to this, and the correlation may include various relationships between the educator 1 and the learner 2. For example, the number of educators 1 and the amount of speech of the learner 2 may be treated as a correlation.

Further, when the first learner action information and the second learner action information are different from each other, the evaluation unit 16 sets the evaluation value higher than that when the first learner action information and the second learner action information are identical to each other.

In this embodiment, when the first learner action information and the second learner action information are different from each other and if the second learner action information is set as more positive action information than the first learner action information, the evaluation value is set high. For example, when the amount of speeches of the students 35 in the pod A increases due to the speech of the TA 34, a high evaluation value is given to the TA 34.

Note that the setting method for the evaluation value to be set for the action information is not limited. For example, when attention is focused on the negative action information of the educator 1, if the first learner action information and the second learner action information are different from each other and if the second learner action information is set as more negative action information than the first learner action information, the evaluation value may be set high. In other words, the magnitude of the evaluation value is set on the basis of the action information of the educator 1 or the learner 2 that the user 3 wants to focus on.

Note that “positive” typically includes activating an educational situation. For example, it is an act such as advice to increase the amount of speech of the learner 2. Further, “negative” also includes inactivating an educational situation. For example, it is an act of lowering the amount of speech of the learner 2. The present technology is not limited to this, and a desired action for the educational situation may be set as a positive action.

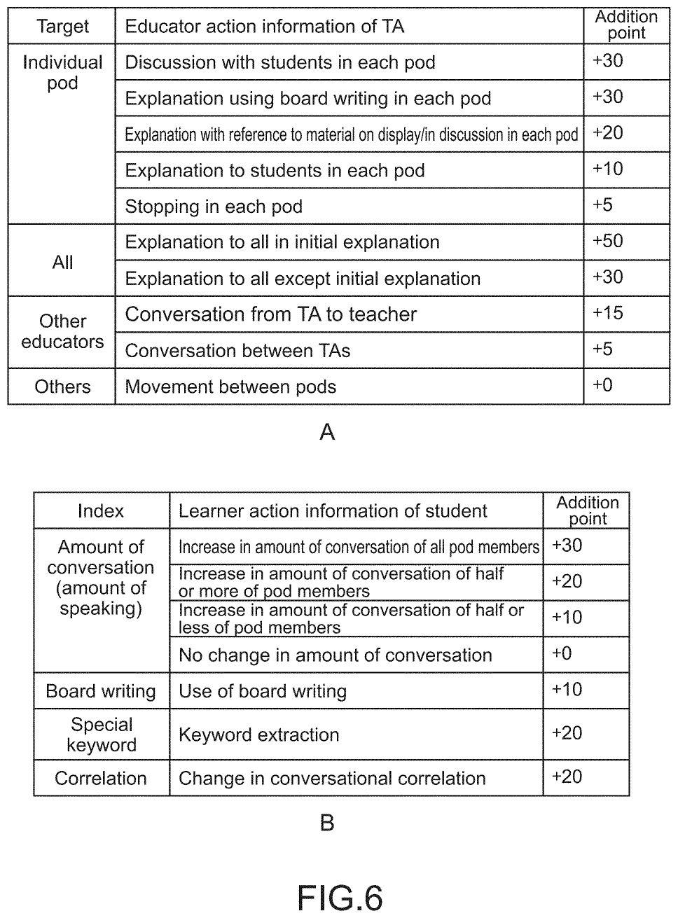

In this embodiment, the evaluation value of a corresponding correlation is set by referring to the evaluation table registered in advance in the evaluation table DB 17. A specific example of the correlation and a specific example of the evaluation value will be described with reference to FIG. 6.

The evaluation table DB 17 stores an evaluation table for setting evaluation values relating to educational situations. In this embodiment, a counterpart to which the speech and action of the TA 34 are directed, the educator action information of the TA 34, and an addition point are stored (see A of FIG. 6). Further, specific examples of changes in the learner action information of the students 35 in each pod, triggered by the educator action information of the TA 34, and addition points are stored (see B of FIG. 6). Note that, in this embodiment, the evaluation value is the total point of the addition points.

The evaluation correspondence processing unit 18 can execute various types of processing on the basis of the evaluation value input from the evaluation unit 16. In this embodiment, it is possible to edit the sensing result including the content for confirming the educational situation on the basis of the evaluation value.

In this embodiment, the evaluation correspondence processing unit 18 includes an editing unit 19, a recording editing unit 20, and a notification unit 21.

On the basis of the evaluation value input from the evaluation unit 16, the editing unit 19 generates an editing point along the time axis for the content obtained by imaging the class. In this embodiment, the editing points are generated at predetermined times along the time axes of the content on the basis of the educator action information of the TA 34, the learner action information of the student 35, and the evaluation values of the TA 34 and the student 35.

For example, the editing unit 19 generates an editing point on the basis of the time when the evaluation value largely fluctuates.

In addition, the editing unit 19 smooths the evaluation value of the content in the time zone sandwiched between the editing points (hereinafter, referred to as partial content). For example, when a piece of partial content is 1-minute content and the evaluation value is calculated every 10 seconds, the average of the calculated evaluation values is calculated as a representative evaluation value of the partial content.

The editing unit 19 outputs each piece of partial content and a representative evaluation value calculated in each piece of partial content, as content information, to the recording editing unit 20.

The recording editing unit 20 edits the sensing result recorded in the recording unit 11, which can be used as content, on the basis of the editing point set by the editing unit 19. For example, processing in which recording is not performed is executed for partial content having a low representative evaluation value of a sensing result (usable as content) recorded in the recording unit 11. Further, it is also possible to execute the processing of recording partial content when the representative evaluation value of the partial content output by the editing unit 19 exceeds a threshold value.

Further, the recording editing unit 20 can increase the amount of information of the partial content recorded in the recording unit 11.

The amount of information is typically defined by the amount of data of the content. For example, the amount of information can be defined by the number of bits of an image per unit time, the number of pixels of an image per unit time, or the like. In addition, the amount of information may be defined on the basis of the gradation value or the like.

For example, the amount of information of the partial content to be recorded is increased by an increase in the bit rate, an increase in the resolution, an increase in the gradation value, a conversion of the display format, or the like. Of course, the present technology is not limited to the above.

Note that the recording editing unit 20 may execute the reduction in the amount of information such as the reduction in the resolution for the partial content whose representative evaluation value does not exceed the threshold value, that is, the partial content whose representative evaluation value is low. Further, the partial content with the reduced amount of information may be recorded in the recording unit 11.

The notification unit 21 makes a proposal to the user 3. In this embodiment, proposal information relating to the educational situation is presented on the basis of the evaluation value. For example, when the average of the evaluation values calculated for each piece of partial content falls below a predetermined threshold, an image or sound indicating a warning may be presented as proposal information to the user 3. Further, for example, a button or the like with which whether to record each piece of partial content selected by the recording editing unit 20 can be selected may be displayed as proposal information on the display of the user terminal 25.

Further, the notification unit 21 presents an instruction relating to the educational situation to the TA 34 on the basis of the evaluation value. For example, when the evaluation value of the TA 34 falls below a predetermined threshold, proposal information indicating whether to propose a teaching method for the class to the TA 34 may be presented. In other words, the proposal of the teaching method for the class to the TA 34 corresponds to an instruction on the class.

Further, the notification unit 21 may display the above-mentioned proposal information on the display unit of the user terminal 25. For example, a dedicated GUI may be generated, and the user 3 may be capable of controlling the position of the editing point or browsing the content in which the educational situation is recorded via the GUI. In this case, it can also be said that the notification unit 21 functions as a UI display control unit. Of course, the UI display control unit may be configured separately from the notification unit 21.

The user terminal 25 includes a display unit 26 and a processing unit 27.

The display unit 26 includes any UI device, e.g., an image display device such as a projector or a display, a sound output device such as a speaker, or an operation device such as a keyboard, a switch, a pointing device, or a remote controller. Of course, a device having both functions of an image display device and an operation device, such as a touch panel, is also included.

In addition, various GUIs displayed on a display, a touch panel, or the like can be considered as elements included in the display unit 26.

The processing unit 27 can execute various types of processing on the basis of an instruction input by the user 3, a control signal input from the information processing apparatus 10, and the like. For example, various types of processing including browsing of content, confirmation of evaluation values, proposal relating to classes, and the like are executed.

The user 3 can evaluate the educational situation by confirming the partial content selected by the recording editing unit 20 via the user terminal 25. Therefore, the evaluation value can be one index for the user 3 to evaluate the educational situation. Further, the evaluation value can also be a criterion for the user 3 to decide to evaluate the educational situation. In other words, it can be said that the partial content selected by the recording editing unit 20 includes useful information for the user 3 to evaluate the educational situation.

Note that the partial content itself generated by the editing unit 19 may be regarded as evaluation.

Note that, in this embodiment, the evaluation unit 16 corresponds to an evaluation unit that sets an evaluation value relating to an educational situation on the basis of a correlation between the educator action information, which is a classification result obtained by classifying the action of the educator into one of a plurality of educator action patterns, and the learner action information, which is a classification result obtained by classifying the action of the learner into one of a plurality of learner action patterns.

Note that, in this embodiment, the analysis unit 13 corresponds to an analysis unit that classifies the action of the educator into one of the plurality of educator action patterns to generate the educator action information, classifies the action of the learner into one of the plurality of learner action patterns to generate the learner action information, and outputs the generated educator action information and learner action information to the evaluation unit.

Note that, in this embodiment, the microphone 29 (31) and the camera 30 (32) correspond to a sensor unit that outputs a sensing result to the analysis unit.

Note that, in this embodiment, the evaluation correspondence processing unit 18 corresponds to an evaluation correspondence processing unit that processes a sensing result on the basis of an evaluation value.

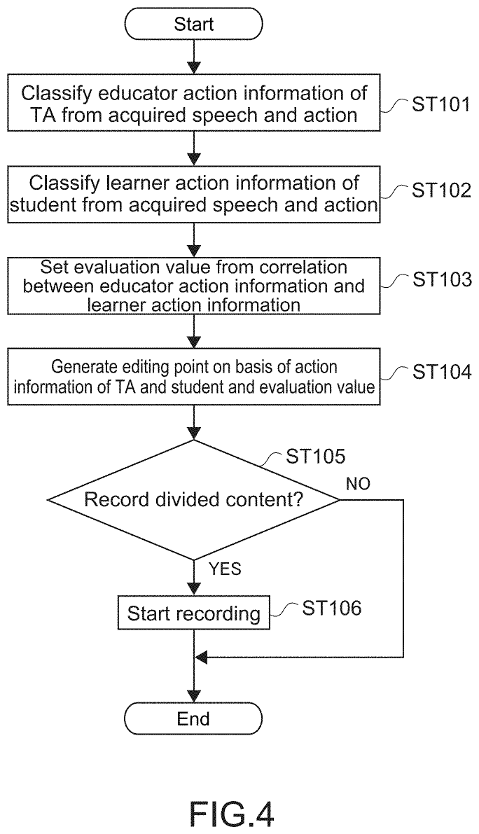

FIG. 4 is a flowchart showing an example of setting an evaluation value.

As shown in FIG. 4, the educator action analysis unit 14 classifies educator action information of the TA 34 from the sensing results acquired from the microphone 29 and the cameras 30 (Step 101).

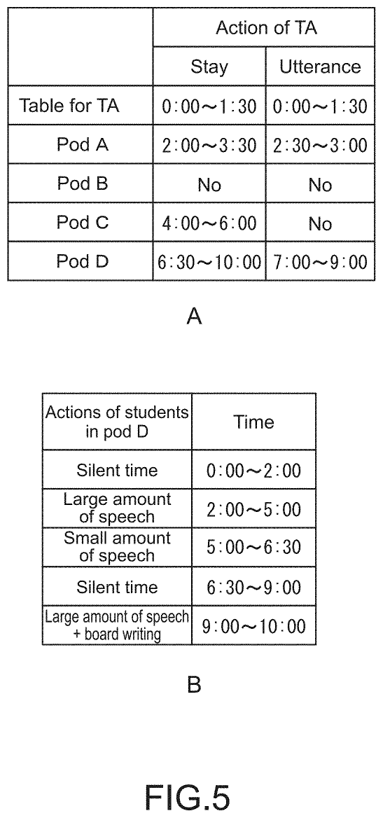

FIG. 5 shows tables showing the speeches and actions of the TA 34 and the students 35 in class.

Note that, in this embodiment, the TA 34 is set as a target to be evaluated. In other words, the target, the action information, the addition point, and the like shown in FIG. 6 are points for evaluating the TA 34. Different targets, different action information, different addition points, and the like are stored as the evaluation table when the student 35 and the like are evaluated.

A of FIG. 5 is a table showing the speeches and actions of the TA 34 in class. Examples of Step 101 will be described specifically with reference to A of FIG. 5.

As shown in A of FIG. 5, the TA 34 performs explanation for all the students 35 in front of the monitor 37 from 0:00 to 1:30. 0:00 includes the time at which the class is started. Needless to say, the present technology is not limited to this. 0:00 may include a recording start time when recording is started from a predetermined time in class.

The TA 34 moves from the table 38 for the TA 34 to the pod A between 1:30 and 2:00 (dashed line 45). As shown in A of FIG. 5, the TA 34 stays in the vicinity of the pod A between 2:00 and 3:30. Further, the TA 34 utters words to the students 35 of the pod A between 2:30 and 3:00.

For example, between 2:00 and 2:30, the educator action analysis unit 14 analyzes that the TA 34 stays in the pod A from the information acquired by the camera 30, and analyzes that the TA 34 does not utter words because the sound pressure cannot be detected by the microphone 29. Further, between 2:30 and 3:00, the educator action analysis unit 14 analyzes that the TA 34 stays in the pod A from the information acquired by the camera 30, and analyzes that the TA 34 utters words because the sound pressure can be detected by the microphone 29.

For example, if the TA 34 stays without uttering words, the TA 34 confirms the content of the discussion in the pod where the TA 34 is staying. When uttering words and staying, the TA 34 provides support such as advice for the discussion in the pod where the TA 34 is staying.

Those analysis results are output to the evaluation unit 16 as the educator action information of the TA 34.

The TA 34 moves from the pod A to the pod C between 3:30 and 4:00 (dashed line 46). As shown in A of FIG. 5, the TA 34 stays in the pod C between 4:00 and 6:00. Note that, since the sound pressure is not detected by the microphone 29 at that time, the TA 34 does not utter words in the pod C.

In such a manner, A of FIG. 5 describes “no” when the TA 34 does not stay or utter words from the sensing results acquired from the microphone 29 and the cameras 30.

The TA 34 moves from the pod C to the pod D between 6:00 and 6:30 (dashed line 47). As shown in A of FIG. 5, the TA 34 stays in the pod C between 6:30 and 10:00. Further, the TA 34 utters words between 7:00 and 9:00.

Further, the learner action analysis unit 15 classifies the learner action information of the student 35 from the sensing results acquired from the microphone 31 and the camera 32 (Step 102). For example, face identification is performed from the video of the camera 32 disposed in each pod, and the action of the student 35 is grasped by tracking, posture estimation, and the like of the student 35. Further, the sound pressure is detected from the microphone 31 disposed in each pod, and the presence or absence of speeches is grasped.

B of FIG. 5 is a table showing the actions of the students 35 in the pod D.

Examples of Step 102 will be described specifically with respect to B of FIG. 5. In this embodiment, attention is paid to the students 35 of the pod D.

As shown in B of FIG. 5, in this embodiment, the students 35 in the pod D are silent because they are listening to the explanation of the TA 34 between 0:00 and 2:00. As a result, the learner action analysis unit 15 classifies the actions of the students 35 into the learner action information of the students 35, called “silent time”.

The students 35 in the pod D have a high utterance rate of each student 35 between 2:00 and 5:00. As a result, the learner action analysis unit 15 classifies the actions of the students 35 into the learner action information of the students 35, called “large amount of speech”. The utterance rate is the rate of utterance of the students 35 performed in a predetermined period of time. For example, if the students 35 speak during two and a half minutes in three minutes, this case is classified into the learner action information called “large amount of speech”, because of the high utterance rate.

The students 35 in the pod D have a low utterance rate of each student 35 between 5:00 and 6:30. As a result, the learner action analysis unit 15 classifies the actions of the students 35 into the learner action information of the students 35, called “small amount of speech”.

The students 35 in the pod D have a low utterance rate of each student 35 between 6:30 and 9:00. As a result, the learner action analysis unit 15 classifies the actions of the students 35 into the learner action information of the students 35, called “silent time”.

In this embodiment, as shown in A of FIG. 5, the TA 34 supports the discussion of the students 35 in the pod D between 7:00 and 9:30, so the students 35 are listening to the advice of the TA 34.

The students 35 in the pod D have a high utterance rate of each student 35 between 9:00 and 10:00. As a result, the learner action analysis unit 15 classifies the actions of the students 35 into the learner action information of the students 35, called “large amount of speech”. In addition, since the student 35 starts writing on the whiteboard 36, the actions of the students 35 are classified into the learner action information of the students 35, called “board writing”, on the basis of the camera 32.

The evaluation unit 16 sets an evaluation value on the basis of a correlation between the educator action information of the TA 34 and the learner action information of the students 35 (Step 103).

FIG. 6 shows examples of an evaluation table for calculating an evaluation value. A of FIG. 6 is a table showing specific examples of the action information of the TA 34 and respective addition points.

As shown in A of FIG. 6, the evaluation table of the TA 34 stores “target”, “educator action information of TA”, and “addition point”.

The “target” indicate a target for the educator action information of the TA 34. Typically, the “target” corresponds to students 35 who are spoken to by the TA 34, teachers who coach the TA 34, and the like. In this embodiment, the “target” is classified into individual pod, all, other educators, and others.

The individual pods are the pods A, B, C, and D. Further, all is targeted at all the pods. Other educators are those who correspond to the educators 1 like the TA 34. For example, other educators include TAs like the TA 34, teachers who coach the TA 34, and the like. Others include movement between the pods, and the like.

Note that the pod also includes the students 35 located there. In other words, the description that the TA 34 speaks to the pod A means the same as that the TA 34 speaks to a plurality of students 35 or one student 35 located in the pod A.

Of course, if the TA 34 speaks to all the pods (all), it can also be said that the TA 34 speaks to all the students 35 in the classroom. Further, if the TA 34 speaks to a student 35, it means the same as that the TA 34 speaks to the individual pod in which the student 35 is located.

“Educator action information of TA” is information obtained by classifying the educator action information of the TA 34 performed on the respective targets. In this embodiment, the educator action information of the TA 34 is classified as follows.

“Addition point” is an index for evaluating the TA 34. In this embodiment, since the TA 34 is an evaluation target, a high score (evaluation value) is assigned to the educator action information when the TA 34 is evaluated to be excellent.

Discussion with students in each pod include situations in which the TA 34 and the students 35 exchange opinions with each other. The “addition point” for this educator action information is 30 points.

Explanation using board writing in each pod include situations in which the TA 34 provides explanations to the students 35 using the whiteboard 36 placed in each pod. For example, this corresponds to the case where the TA 34 provides explanations while drawing figures on the whiteboard 36. The “addition point” for this educator action information is 30 points.

Explanation with reference to a material on the display or in the discussion in each pod includes situations in which the TA 34 provides explanations to the student 35 in a manner other than board writing. For example, this corresponds to the case where the TA 34 provides explanations using a material of a paper medium used for active learning or a material displayed on the display as a data file. The “addition point” for this educator action information is 20 points.

Explanation to students in each pod includes situations in which the TA 34 unilaterally provides explanations to the students 35. For example, this corresponds to the case where the students 35 are silent while the TA 34 is providing explanations. The “addition point” for this educator action information is 10 points.

Stopping in each pod includes situations where the TA 34 stays near the pod and does not speak. For example, this corresponds to the case where the TA 34 confirms discussions performed in the pod, for example. The “addition point” for this educator action information is 5 points.

Explanation to all in the initial explanation includes the situation in which explanation on the agenda is given when the class is conducted. For example, this corresponds to the case where the TA 34 explains the background of problems on the agenda of active learning, the issues to be discussed, or the like. The “addition point” for this educator action information is 50 points.

Explanation to all except the initial explanation includes a situation in which the overall explanation performed after the initial explanation is performed. For example, this corresponds to the case where the discussions being held in all the pods are far from the answer, and the TA 34 explains the modification of the track to all. The “addition point” for this educator action information is 30 points.

Conversation from the TA to a teacher include a situation in which conversations are held with educators other than the TA 34 and with higher-ranking persons than the TA 34. For example, this corresponds to the case where the TA 34 reports to a teacher on the overall progress and the like. The “addition point” for this educator action information is 15 points.

Conversation between TAs include a situation in which TAs have conversation with educators who are other than the TA 34 and have the same position as the TA 34. For example, this corresponds to the case where the TAs 34 exchange opinions about advice to the students 35 and the like. The “addition point” for this educator action information is 5 points.

Movement between pods includes a situation in which no speech or action is given to a target such as movement in each pod or within the classroom. The “addition point” for this educator action information is 0 points.

B of FIG. 6 is a table showing specific examples of the situation changes of the learner action information of the student 35, which are triggered by the educator action information of the TA 34, and respective addition points.

As shown in B of FIG. 6, the evaluation table stores “index”, “learner action information of student”, and “addition point”.

The “index” includes an index of a change with respect to the learner action information of the student 35. For example, the index of the student 35 is activation of discussions in the pod, execution of an action such as board writing, and the like. In other words, the index can also be referred to as a reaction of the student 35 with respect to the action of the TA 34. In this embodiment, the “index” is classified into the amount of conversation (amount of speaking), board writing, a special keyword, and a correlation.

The amount of conversation indicates the amount of conversation of the students 35 in a pod. The board writing indicates an action in which the student 35 writes the content of the discussion on the whiteboard 36 or the like. The special keyword indicates a case where a predetermined keyword is given through the board writing or speeches of the students 35. The correlation shows the influence of the action information of the TA 34 on the pod.

“Learner action information of student” is information obtained by classifying the situation change of the learner action information of the students 35, which is triggered by the educator action information of the TA 34. In other words, “learner action information of student” is a specific example of a change of the index before and after the TA 34 speaks or take actions to the students 35. In this embodiment, the learner action information of the students 35 is classified as follows.

The increase in the amount of conversation of all the pod members includes a situation in which the amount of conversation of all the students 35 located in the pod is increased. In this embodiment, the pod members are four students 35 who are located in a pod. The “addition point” for this learner action information is 30 points.

The increase in the amount of conversation of half or more of the pod members includes a situation in which the amount of conversation of half or more of the students 35 located in the pod is increased. The “addition point” for this learner action information is 20 points.

The increase in the amount of conversation of half or less of the pod members includes a situation in which the amount of conversation of half or less of the students 35 located in the pod is increased. The “addition point” for this learner action information is 10 points.

“No change in the amount of conversation” includes a situation in which the amount of conversation of the students 35 does not change before and after the TA 34 speaks or takes actions. The “addition point” for this learner action information is 0 points.

Use of board writing includes a situation in which the student 35 writes content relating to discussions on the whiteboard 36 or the like. For example, this corresponds to an act of taking a note of the speeches of the TA 34 on the whiteboard 36. The “addition point” for this learner action information is 10 points.

Keyword extraction indicates a situation in which a keyword for deriving an answer to the discussion, which has been determined in advance, is extracted. For example, this corresponds to a case where a keyword registered in advance is detected from the content of the speech of the student 35 by voice recognition or image recognition. The “addition point” for this learner action information is 20 points.

Change in conversational correlation includes a situation in which the conversation in a pod is changed when the TA speaks or takes actions to the pod. For example, this corresponds to a case where the speech of the TA 34 changes the conversations between the students 35 in a positive way, for example.

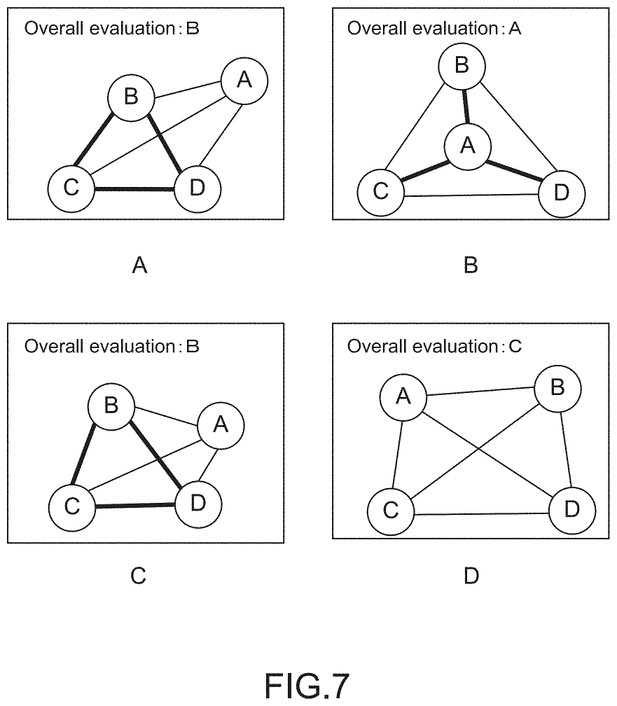

FIG. 7 is a schematic diagram showing the correlations in conversations of the students 35.

FIG. 7 shows the correlations between the conversations by students A, B, C, and D. The line connecting the persons indicates the relationship of conversation. In this embodiment, the thickness of the line represents the total amount of conversation in both ends in a fixed period. Further, the length of the line represents the frequency of conversation. Further, in FIG. 7, an overall evaluation is provided for each correlation. Note that D is the lowest overall evaluation and A is the highest overall evaluation.

For example, A of FIG. 7 means that the total amount and frequency of conversation by the student B, the student C, and the student D are high. Further, for example, B of FIG. 7 means that the total amount and frequency of conversation between the students A and B, the students A and C, and the students A and D are high. Further, B of FIG. 7 means that the total amount and frequency of conversation between the students B and C, the students B and D, and the students C and D are low.

In this embodiment, evaluations are performed on the basis of changes in correlations shown in A to D of FIG. 7. For example, when the TA 34 makes an advice and the correlation is changed from the diagram D to the diagram B, the overall evaluation rises from the overall evaluation C to the overall evaluation A, so that 20 points are added. Further, for example, when the correlation changes from the diagram A to the diagram C or D, the overall evaluation is the same or drops, so that 0 points are added.

Note that the overall evaluation and the addition of the evaluation values based on the relationship among the students A, B, C, and D are not limited. For example, if the overall evaluation drops, the evaluation value may be subtracted.

Note that the type of the action information is not limited. For example, the action information may include a search for keywords relating to the class, creation of materials, and the like by the student 35 using a terminal such as a smartphone. Further, for example, the action information may include the facial expression of the student 35 or the like. Further, the type of evaluation information and the addition method are not limited. For example, the action information and the addition point may be set according to the type of the class.

The editing unit 19 generates an editing point at a predetermined time of content 50 in which an educational situation is imaged, on the basis of the educator action information of the TA 34, the learner action information of the student 35, and the evaluation information (Step 104).

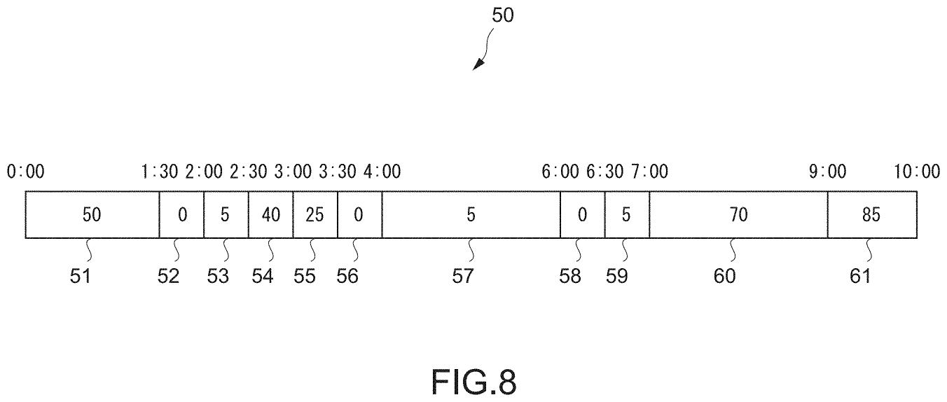

FIG. 8 is a schematic diagram showing the segments of partial content of a class and the evaluation value of each piece of partial content. In this embodiment, the evaluation unit 16 generates an evaluation value relating to the TA 34 on the basis of the educator action information of the TA 34 and the learner action information of the students 35 for the 10-minute class. Further, the editing unit 19 generates an editing point every time the evaluation value changes.

As shown in A of FIG. 5 and FIG. 8, the TA 34 provides the initial explanation of the class to all the pods between 0:00 and 1:30. On the basis of the sensing results of the microphone 29 and the cameras 30, the educator action analysis unit 14 generates educator action information of the TA 34, “explanation to all in the initial explanation”. On the basis of the evaluation table shown in FIG. 6, the evaluation unit 16 evaluates the addition point of the TA 34 between 0:00 and 1:30 as 50 points.

Further, the TA 34 moves from the table 38 for the TA 34 to the pod A between 1:30 and 2:00. As shown in FIG. 6, the addition point of this educator action information is 0 points. In other words, as shown in FIG. 8, since the evaluation value fluctuates, the editing unit 19 generates partial content 51 between 0:00 and 1:30, which has a representative evaluation value of 50 points. In other words, an editing point is generated at the time of 1:30.

The TA 34 stays in the vicinity of the pod A between 2:00 and 2:30 and does not utter words. On the basis of the sensing results of the microphone 29 and the cameras 30, the educator action analysis unit 14 generates educator action information of the TA 34, “stopping in the pod A”. On the basis of the evaluation table shown in FIG. 6, the evaluation unit 16 evaluates the addition point of the TA 34 between 2:00 and 2:30 as 5 points.

The editing unit 19 generates partial content 52 between 1:30 and 2:00, which has a representative evaluation value of 0 points.

The TA 34 stayed in the vicinity of the pod A between 2:30 and 3:00 and uttered words. Further, a situation in which the student 35 of the pod A converses with the TA 34 was detected from the microphone 31 and the cameras 32. From the sensing results of the microphone 29 and the cameras 30, the educator action analysis unit 14 generates educator action information of the TA 34, “discussion with students in each pod”, and the learner action analysis unit 15 generates action information of the student 35, “increase in amount of conversation of half or less of pod members”. On the basis of the evaluation table shown in FIG. 6, the evaluation unit 16 evaluates the addition point of the TA 34 between 2:30 and 3:00 as 40 points.

The editing unit 19 generates partial content 53 between 2:00 and 2:30, which has a representative evaluation value of 5 points.

The TA 34 stays in the vicinity of the pod A and does not utter words between 3:00 and 3:30. Further, a situation in which the amount of conversation between the students 35 of the pod A is increased was detected from the microphone 31 and the camera 32. From the sensing results of the microphone 29 and the camera 30, the educator action analysis unit 14 generates educator action information of the TA 34, “stopping in each pod”, and the learner action analysis unit 15 generates learner action information of the students 35, “increase in amount of conversation of half or more of pod members”. On the basis of the evaluation table shown in FIG. 6, the evaluation unit 16 evaluates the addition point of the TA 34 between 3:00 to 3:30 as 25 points.

The editing unit 19 generates partial content 54 between 2:30 and 3:00, which has a representative evaluation value of 40 points.

The TA 34 moves from the pod A to the pod C between 3:30 and 4:00 and does not utter words. From the sensing results of the microphone 29 and the cameras 30, the educator action analysis unit 14 generates educator action information of the TA 34, “movement between pods”. On the basis of the evaluation table shown in FIG. 6, the evaluation unit 16 evaluates the addition point of the TA 34 between 3:30 and 4:00 as 0 points.

The editing unit 19 generates partial contents 55 between 3:00 to 3:30, which has a representative evaluation value of 25 points.

The TA 34 stays in the vicinity of the pod C between 4:00 and 6:00 and does not utter words. On the basis of the sensing results of the microphone 29 and the cameras 30, the educator action analysis unit 14 generates educator action information of the TA 34, “stopping in each pod”. On the basis of the evaluation table shown in FIG. 6, the evaluation unit 16 evaluates the addition point of the TA 34 between 4:00 and 6:00 as 5 points.

The editing unit 19 generates partial content 56 between 3:30 and 4:00, which has a representative evaluation value of 0 points.

The TA 34 moves from the pod C to the pod D and does not utter words between 6:00 and 6:30. From the sensing results of the microphone 29 and the cameras 30, the educator action analysis unit 14 generates educator action information of the TA 34, “movement between pods”. On the basis of the evaluation table shown in FIG. 6, the evaluation unit 16 evaluates the addition point of the TA 34 between 6:00 and 6:30 as 0 points.

The editing unit 19 generates partial content 57 between 4:00 to 6:00, which has a representative evaluation value of 5 points.

The TA 34 stays in the vicinity of the pod D and does not utter words between 6:30 and 7:00. On the basis of the sensing results of the microphone 29 and the cameras 30, the educator action analysis unit 14 generates educator action information of the TA 34, “stopping in each pod”. On the basis of the evaluation table shown in FIG. 6, the evaluation unit 16 evaluates the addition point of the TA 34 between 6:30 and 7:00 as 5 points.

The editing unit 19 generates partial content 58 between 6:00 and 6:30, which has a representative evaluation value of 0 points.

The TA 34 stayed in the vicinity of the pod D and uttered words between 7:00 and 9:00. Further, a situation in which the student 35 of the pod D performs board writing was detected from the camera 32. On the basis of the sensing results of the microphone 29 and the cameras 30, the educator action analysis unit 14 generates educator action information of the TA 34, “explanation using board writing in each pod”, “explanation with reference to material on display or in discussion in each pod”, and “explanation to students in each pod”, and the learner action analysis unit 15 generates learner action information of the student 35, “use of board writing”. On the basis of the evaluation table shown in FIG. 6, the evaluation unit 16 evaluates the addition point of the TA 34 between 7:00 and 9:00 as 70 points.

The editing unit 19 generates partial content 59 between 6:30 and 7:00, which has a representative evaluation value of 5 points.

The TA 34 stays in the vicinity of the pod D and does not utter words between 9:00 and 10:00. Further, a situation in which the students 35 of the pod D have conversations and perform board writing was detected from the microphone 31 and the camera 32. From the sensing results of the microphone 29 and camera 30, the educator action analysis unit 14 generates educator action information of the TA 34, “stopping in each pod”. In addition, the learner action analysis unit 15 generates learner action information of the students 35, “increase in amount of conversation of all pod members”, “use of board writing”, “keyword extraction”, and “change in conversational correlation”. On the basis of the evaluation table shown in FIG. 6, the evaluation unit 16 evaluates the addition point of the TA 34 between 7:00 and 9:00 as 85 points.

The editing unit 19 generates partial content 60 between 7:00 and 9:00, which has a representative evaluation value of 70 points. In addition, the editing unit 19 generates partial content 61 between 9:00 and 10:00 (end of class), which has a representative evaluation value of 85 points.

The recording editing unit 20 selects partial content to be recorded from the divided content on the basis of the representative evaluation value (Step 105).

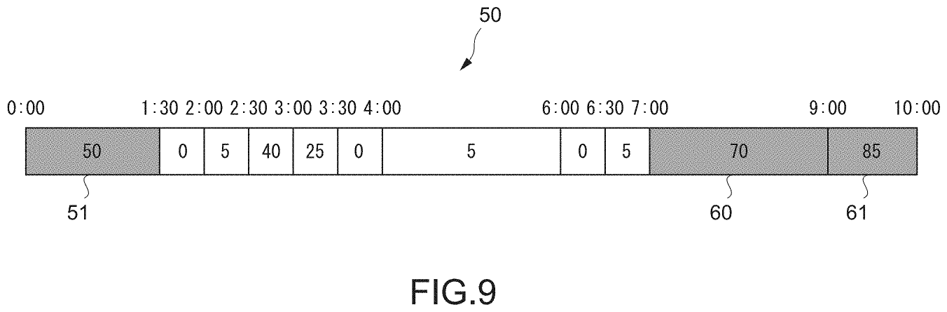

FIG. 9 is a schematic diagram showing the partial content to be recorded.

In this embodiment, the recording editing unit 20 selects partial content having a representative evaluation value of 50 points or more. Note that the threshold value of the representative evaluation value of the partial content selected by the recording editing unit 20 is not limited and may be arbitrarily determined. For example, the threshold value may be set by the user 3.

As shown in FIG. 9, the recording editing unit 20 selects the partial content 51, the partial content 60, and the partial content 61 whose representative evaluation values are 50 points or more (YES in Step 105). The recording editing unit 20 records a moving image of a time corresponding to each of the selected partial content (Step 106).

In addition, no recording is performed for the partial content whose representative evaluation value is 50 points or less (NO in Step 105).

As described above, the information processing apparatus 10 according to this embodiment sets the evaluation value 8 relating to the educational situation on the basis of the correlation between the educator action information 6, which is a classification result obtained by classifying the action of the educator 1 into one of a plurality of educator action patterns, and the learner action information 7, which is a classification result obtained by classifying the action of the learner 2 into one of a plurality of learner action patterns. As a result, it is possible to perform an evaluation that has not been performed so far.

In the education of lectures and classes at schools, the form of active learning or the like in which students can actively learn is being adopted in place of the form in which students on the learning side passively learn from teachers on the educational side.

It is important to properly evaluate and instruct not only students but also teachers or TAs in the educational style such as active learning. For example, an attempt is made to image a class scene of the active learning in order to evaluate a teacher or TA after the class.

However, checking each video of each pod when checking the class scene is a very time-consuming task. Further, storage costs increases because all videos are recorded and saved.

In the present invention, an analysis of the action of the teacher or TA and an analysis of the action of the student are performed, and a correlation between both pieces of information is obtained, so that more detailed evaluation value is calculated. In addition, the optimal partial content is automatically segmented according to the evaluation value. The segmented partial content is recorded on the basis of the evaluation value. As a result, it is possible to efficiently and accurately perform evaluation. In addition, it is possible to reduce the time required for checking when the evaluation is performed. Furthermore, it is possible to reduce the storage costs at the time of recording.

### Other Embodiments

The present technology is not limited to the embodiment described above and can implement other various embodiments.

In the above embodiment, the evaluation system 100 includes both the educator 1 and the learner 2. The present technology is not limited to this, and only the educator 1 or the learner 2 may be used. For example, the student 35 viewing a video of the lecture may be evaluated. In this case, opening a reference book, looking away, taking a note on a notebook, or the like may be handled as evaluation information.

Further, for example, a TA 34 who is practicing for a class may be evaluated. At that time, the number of gestures, the volume of voice, or the like may be handled as evaluation information.

In the above embodiment, the addition point is used as the method of evaluating an evaluation target. The present technology is not limited to this, and subtraction of points may be used for specific action information. For example, if the conversation is not related to the class, 20 points may be subtracted. Further, for example, if the amount of conversation of the students 35 decreases due to the speech of the TA 34, the evaluation value of the TA 34 may be subtracted.

In the above embodiment, the analysis results of the educator action analysis unit 14 and the learner action analysis unit 15 are handled as action information. The present technology is not limited to this, and a sensing result acquired by a sensor unit such as the microphone 29 (31) and the camera 30 (32) may be used as action information. For example, the evaluation unit 16 may generate an evaluation value of the TA 34 when the sound pressure of the pod A increases.

In the above embodiment, the camera 30 for the TA 34 detects the movement, stay, and the like of the TA 34. The present technology is not limited to this, and a beacon capable of detecting the positional information of the TA 34 may be included in the sensor unit.

Further, the microphone 29 (31) detects the speeches of the TA 34 and the students 35. The present technology is not limited to this, and the speeches of the TA 34 and the student 35 may be detected by recognizing the movement of the mouths by the camera 30 (32).

In the above embodiment, the bit rate of the partial content not selected by the recording editing unit 20 is lowered or recording is not executed. The present technology is not limited to this, and the bit rate of the partial content selected by the recording editing unit 20 may be increased. Further, the partial content that has not been selected may be recorded only by sound or video.

In the above embodiment, the action information of the student 35 is evaluated in real time by the evaluation unit 16. The present technology is not limited to this, and the evaluation value may be generated only when the action information of the student 35 changes.

In the above embodiment, the addition point (evaluation information) is set for each piece of action information. The present technology is not limited to this, and the evaluation information may be generated by the information processing apparatus 10 performing machine learning.

In the above embodiment, the sensing result acquired by the sensor unit is input to the information processing apparatus 10 via the reproduction unit 12. The present technology is not limited to this, and the sensing result may be input from the recording unit 11 to the information processing apparatus 10.

In the above embodiment, the recording unit 11 records the content of an educational situation, and the analysis unit 13 analyzes the action information. The present technology is not limited to this, and the processing may be executed in real time by the analysis unit 13 and the evaluation unit 16. In this case, the recording unit 11 may have a function of buffering the sensing result.

In the above embodiment, the information processing apparatus 10 includes the analysis unit 13, the evaluation unit 16, and the evaluation table DB 17. The present technology is not limited to this, and the information processing apparatus 10 may include the recording unit 11, the reproduction unit 12, and the evaluation correspondence processing unit 18. In addition, a configuration of cloud computing may be applied in which the recording unit 11, the reproduction unit 12, and the evaluation correspondence processing unit 18 share one function and cooperate to perform processing via a network.

In the above embodiment, the educator action information and the learner action information are analyzed by the analysis unit 13 and then input to the evaluation unit 16. The present technology is not limited to this, and the analyzed educator action information and learner action information may be input to the evaluation unit 16 from the outside.

FIG. 10 is a block diagram showing a hardware configuration example of the information processing apparatus 10.

The information processing apparatus 10 includes a CPU 81, a read only memory (ROM) 82, a RAM 83, an input/output interface 85, and a bus 84 that connects these components to each other. A display unit 86, an input unit 87, a storage unit 88, a communication unit 89, a drive unit 90, and the like are connected to the input/output interface 85.

The display unit 86 is a display device using liquid crystal, electro-luminescence (EL), or the like. The input unit 87 is, for example, a keyboard, a pointing device, a touch panel, or other operation devices. If the input unit 87 includes a touch panel, the touch panel may be integrated with the display unit 86.

The storage unit 88 is a nonvolatile storage device and is, for example, an HDD, a flash memory, or other solid-state memory. The drive unit 90 is, for example, a device capable of driving a removable recording medium 91 such as an optical recording medium or a magnetic recording tape.

The communication unit 89 is a modem, a router, or other communication device that can be connected to a LAN, a WAN, or the like for communicating with other devices. The communication unit 89 may communicate using either wired or wireless communication. The communication unit 89 is often used separately from the information processing apparatus 10.

In this embodiment, the communication unit 89 allows communication with other devices via the network.

The information processing by the information processing apparatus 10 having the hardware configuration as described above is implemented in cooperation with the software stored in the storage unit 88, the ROM 82, or the like, and the hardware resources of the information processing apparatus 10. Specifically, the information processing method according to the present technology is implemented when a program stored in the ROM 82 or the like and configuring the software is loaded into the RAM 83 and then executed.

The program is installed in the information processing apparatus 10, for example, through the recording medium 81. Alternatively, the program may be installed in the information processing apparatus 10 via a global network or the like. Moreover, any non-transitory computer-readable storage medium may be used.

The information processing apparatus, the information processing method, the program, and the information processing system according to the present technology may be performed, and the information processing apparatus according to the present technology may be constructed, by linking a computer mounted on a communication terminal with another computer capable of communicating via a network or the like.

In other words, the information processing apparatus, the information processing method, and the program according to the present technology can be performed not only in a computer system formed of a single computer, but also in a computer system in which a plurality of computers operates cooperatively. Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The execution of the information processing apparatus, the information processing method, and the program according to the present technology by the computer system includes, for example, both a case in which the generation of action information, the division of content, and the like are performed by a single computer; and a case in which the respective processes are performed by different computers. Further, the execution of each process by a predetermined computer includes causing another computer to perform a portion of or all of the process and obtaining a result thereof.

In other words, the information processing apparatus, the information processing method, and the program according to the present technology are also applicable to a configuration of cloud computing in which a single function is shared and cooperatively processed by a plurality of apparatuses through a network.

The configurations of the educator action analysis unit, the learner action analysis unit, the evaluation unit, the recording editing unit, and the like; the control flow of the communication system; and the like described with reference to the respective figures are merely embodiments, and any modifications may be made thereto without departing from the spirit of the present technology. In other words, any other configurations or algorithms for purpose of practicing the present technology may be adopted.

Note that the effects described in the present disclosure are merely illustrative and not restrictive, and other effects may be obtained. The above description of the plurality of effects does not necessarily mean that these effects are simultaneously exhibited. It means that at least one of the above-mentioned effects can be obtained depending on the conditions and the like, and of course, there is a possibility that an effect not described in the present disclosure can be exhibited.

At least two of the features among the features of the embodiments described above can also be combined. In other words, various features described in the respective embodiments may be combined discretionarily regardless of the embodiments.

Note that the present technology may also take the following configurations.

(1) An information processing apparatus, including

an evaluation unit that sets an evaluation value relating to an educational situation on the basis of a correlation between educator action information, which is a classification result obtained by classifying an action of an educator into one of a plurality of educator action patterns, and learner action information, which is a classification result obtained by classifying an action of a learner into one of a plurality of learner action patterns.

(2) The information processing apparatus according to (1), in which

the correlation is a correlation between the educator action information, and first learner action information and second learner action information as the learner action information.

(3) The information processing apparatus according to (1) or (2), in which

the correlation is a correlation between the first learner action at a first timing, the educator action information at a second timing, which is a timing after the first timing, and the second learner action information at a third timing, which is a timing after the second timing.

(4) The information processing apparatus according to (3), in which

when the first learner action information and the second learner action information are different from each other, the evaluation unit sets the evaluation value higher than an evaluation value in a case where the first learner action information and the second learner action information are identical to each other.

(5) The information processing apparatus according to (4), in which

when the first learner action information and the second learner action information are different from each other, the evaluation unit sets the evaluation value high if the second learner action information is set as more positive action information than the first learner action information.

(6) The information processing apparatus according to (4), in which

when the first learner action information and the second learner action information are different from each other, the evaluation unit sets the evaluation value high if the second learner action information is set as more negative action information than the first learner action information.

(7) The information processing apparatus according to (3), in which

when the first learner action information and the second learner action information are identical to each other, the evaluation unit sets the evaluation value lower than an evaluation value in a case where the first learner action information and the second learner action information are different from each other.

(8) The information processing apparatus according to any one of claims 1) to (7), further including

an analysis unit that
classifies the action of the educator into one of the plurality of educator action patterns to generate the educator action information,
classifies the action of the learner into one of the plurality of learner action patterns to generate the learner action information, and
outputs the generated educator action information and learner action information to the evaluation unit.
   (9) The information processing apparatus according to (8), further including

a sensor unit that outputs a sensing result to the analysis unit, in which

the analysis unit analyzes the action of the educator and the action of the learner on the basis of the sensing result.

(10) The information processing apparatus according to (4), further including

an evaluation correspondence processing unit that processes the sensing result on the basis of the evaluation value.

(11) The information processing apparatus according to (10), in which

the evaluation correspondence processing unit edits the sensing result on the basis of the evaluation value.

(12) The information processing apparatus according to (7), further including

an evaluation correspondence processing unit that processes the sensing result on the basis of the evaluation value.

(13) The information processing apparatus according to (12), in which

the evaluation correspondence processing unit edits the sensing result on the basis of the evaluation value.

(14) An information processing method, which is executed by a computer system, the method including

setting an evaluation value relating to an educational situation on the basis of a correlation between educator action information, which is a classification result obtained by classifying an action of an educator into one of a plurality of educator action patterns, and learner action information, which is a classification result obtained by classifying an action of a learner into one of a plurality of learner action patterns.

(15) A program, which causes a computer system to execute the step of

setting an evaluation value relating to an educational situation on the basis of a correlation between educator action information, which is a classification result obtained by classifying an action of an educator into one of a plurality of educator action patterns, and learner action information, which is a classification result obtained by classifying an action of a learner into one of a plurality of learner action patterns.

### REFERENCE SIGNS LIST

1 educator
2 learner
4 microphone
5 camera
10 information processing apparatus
13 analysis unit
16 evaluation unit
18 evaluation correspondence processing unit
34 TA
35 student
50 content

1. An information processing apparatus, comprising
an evaluation unit that sets an evaluation value relating to an educational situation on a basis of a correlation between educator action information, which is a classification result obtained by classifying an action of an educator into one of a plurality of educator action patterns, and learner action information, which is a classification result obtained by classifying an action of a learner into one of a plurality of learner action patterns.

2. The information processing apparatus according to claim 1, wherein
the correlation is a correlation between the educator action information, and first learner action information and second learner action information as the learner action information.

3. The information processing apparatus according to claim 1, wherein
the correlation is a correlation between the first learner action at a first timing, the educator action information at a second timing, which is a timing after the first timing, and the second learner action information at a third timing, which is a timing after the second timing.

4. The information processing apparatus according to claim 3, wherein
when the first learner action information and the second learner action information are different from each other, the evaluation unit sets the evaluation value higher than an evaluation value in a case where the first learner action information and the second learner action information are identical to each other.

5. The information processing apparatus according to claim 4, wherein
when the first learner action information and the second learner action information are different from each other, the evaluation unit sets the evaluation value high if the second learner action information is set as more positive action information than the first learner action information.

6. The information processing apparatus according to claim 4, wherein
when the first learner action information and the second learner action information are different from each other, the evaluation unit sets the evaluation value high if the second learner action information is set as more negative action information than the first learner action information.

7. The information processing apparatus according to claim 3, wherein
when the first learner action information and the second learner action information are identical to each other, the evaluation unit sets the evaluation value lower than an evaluation value in a case where the first learner action information and the second learner action information are different from each other.

8. The information processing apparatus according to claim 1, further comprising
an analysis unit that
classifies the action of the educator into one of the plurality of educator action patterns to generate the educator action information,
classifies the action of the learner into one of the plurality of learner action patterns to generate the learner action information, and
outputs the generated educator action information and learner action information to the evaluation unit.

9. The information processing apparatus according to claim 8, further comprising
a sensor unit that outputs a sensing result to the analysis unit, wherein
the analysis unit analyzes the action of the educator and the action of the learner on a basis of the sensing result.

10. The information processing apparatus according to claim 4, further comprising
an evaluation correspondence processing unit that processes the sensing result on a basis of the evaluation value.

11. The information processing apparatus according to claim 10, wherein
the evaluation correspondence processing unit edits the sensing result on a basis of the evaluation value.

12. The information processing apparatus according to claim 7, further comprising
an evaluation correspondence processing unit that processes the sensing result on a basis of the evaluation value.

13. The information processing apparatus according to claim 12, wherein
the evaluation correspondence processing unit edits the sensing result on a basis of the evaluation value.

14. An information processing method, which is executed by a computer system, the method comprising
setting an evaluation value relating to an educational situation on a basis of a correlation between educator action information, which is a classification result obtained by classifying an action of an educator into one of a plurality of educator action patterns, and learner action information, which is a classification result obtained by classifying an action of a learner into one of a plurality of learner action patterns.

15. A program, which causes a computer system to execute the step of
setting an evaluation value relating to an educational situation on a basis of a correlation between educator action information, which is a classification result obtained by classifying an action of an educator into one of a plurality of educator action patterns, and learner action information, which is a classification result obtained by classifying an action of a learner into one of a plurality of learner action patterns.
